(19) United States
(12) Patent Application Publication
(10) Pub. No.: US 2015/0334382 A1
(43) Pub. Date: Nov. 19, 2015

(54) METHOD AND APPARATUS FOR CONTENT PRESENTATION

(71) Applicants: Yan XU, Beijing (CN); Lin DU, Beijing (CN); Guanghua ZHOU, Beijing (CN)

(72) Inventors: Yan XU, Beijing (CN); Lin DU, Beijing (CN); Guanghua ZHOU, Beijing (CN)

(21) Appl. No.: 14/655,196

(22) PCT Filed: Dec. 26, 2012
(86) PCT No.: PCT/CN2012/087501

§ 371 Date: Jun. 24, 2015

(51) Int. Cl. H04N 13/04

(52) U.S. Cl. CPC H04N 13/0438

(57) ABSTRACT

It is provided a method for content presentation of a 3D video and a complementary 3D content, wherein the 3D video comprises a left view and a right view and the complementary 3D content comprises a left view and a right view. The complementary 3D content is associated in time with at least a portion of the 3D video, the method comprises the steps of temporally multiplexing the left view and the right view of the portion of the 3D video and the left view and the right view of the complementary 3D content to produce multiplexed data; polarizing the multiplexed data to produce polarized data; presenting the polarized data.

### TECHNICAL FIELD

The present invention relates to data presentation, and more particularly relates to a method and an apparatus for content presentation.

### BACKGROUND

It has been well known to provide subtitles on movies, especially the movies in foreign languages. However, while some people prefer having subtitles, some other people think subtitles affect watching experience and consequently do not want them. And it's possible that sometimes people from different countries want to watch subtitles of their native languages while watching a movie together.

US2010/0177172A Heinrich Shih Ko, etc. provides a stereoscopic screen sharing method and apparatus. It presents a “screen sharing” system in which two or more viewers using the same display can each be provided with different images on the display. The display alternately presents images from at least two video sources and a synchronized, shuttered filter device (e.g. shutter glasses) is used to only permit the viewing of images from a desired video source among the two video sources. The invention can be applied to both 2D video and 3D video (stereoscopic video). Because the invention uses time division technology, the flicker may become noticeable as the number of video source increases.

Therefore, it is desired to add some more video source without causing flicker to the viewers.

### SUMMARY

According to an aspect of present invention, it is provided a method for content presentation of a 3D video and a complementary 3D content, wherein the 3D video comprises a left view and a right view and the complementary 3D content comprises a left view and a right view. The complementary 3D content is associated in time with at least a portion of the 3D video, the method comprises the steps of temporally multiplexing the left view and the right view of the portion of the 3D video and the left view and the right view of the complementary 3D content to produce multiplexed data; polarizing the multiplexed data to produce polarized data; presenting the polarized data.

According to another aspect of the present invention, it is provided a method for viewing content comprising a 3D video and a complementary 3D content, wherein the 3D video comprises a left view and a right view and the complementary 3D content comprises a left view and a right view. The complementary 3D content is associated in time with at least a portion of the 3D video, and the left view and the right view of the 3D video and the right view of the complementary 3D content are temporally multiplexed and polarized to produce polarized data to be presented on the display, the method comprises the steps of performing polarization on the polarized data to produce multiplexed data, wherein the multiplexed data comprises time slots conveying the left view and the right of the 3D video and the left view and the right of the complementary 3D content; and synchronizing to time slots on the multiplexed data, wherein, the time slots corresponds to content among the 3D video and the complementary 3D content a viewer desires to watch.

According to another aspect of the present invention, it is provided an apparatus for content presentation of a 3D video and a complementary 3D content, wherein the 3D video comprises a left view and a right view and the complementary 3D content comprises a left view and a right view. The complementary 3D content is associated in time with at least a portion of the 3D video, the apparatus comprises a multiplexer module for temporally multiplexing the left view and the right view of the portion of the 3D video and the left view and the right view of the complementary 3D content to produce multiplexed data; a polarization module for polarizing the multiplexed data to produce polarized data; and a screen for presenting the polarized data.

According to another aspect of the present invention, it is provided an apparatus for viewing content comprising a 3D video and a complementary 3D content, wherein the 3D video comprises a left view and a right view and the complementary 3D content comprises a left view and a right view. The complementary 3D content is associated in time with at least a portion of the 3D video, and the left view and the right view of the 3D video and the right view of the complementary 3D content are temporally multiplexed and polarized to produce polarized data to be presented on the display, the apparatus comprises a polarization filter for performing polarization on the polarized data to produce multiplexed data, wherein the multiplexed data comprises time slots conveying the left view and the right of the 3D video and the left view and the right of the complementary 3D content; and a shutter for synchronizing to time slots on the multiplexed data, wherein, the time slots corresponds to content among the 3D video and the complementary 3D content a viewer desires to watch.

It is to be understood that more aspects and advantages of the invention will be found in the following detailed description of the present invention.

### BRIEF DESCRIPTION OF THE DRAWINGS

The accompanying drawings, which are included to provide a further understanding of the, illustrate embodiments of the invention together with the description which serves to explain the principle of the invention. Therefore, the invention is not limited to the embodiments. In the drawings:

FIG. 1 is a block diagram showing the presentation apparatus according to the embodiment of the present invention;

FIG. 2 is block diagram showing the shutter glass according to the embodiment of the present invention;

FIG. 3 is a flow chart showing a method for presenting the content according to the embodiment of the present invention;

FIG. 4 is a diagram showing the polarized left view and polarized right view according to the embodiment of the present invention;

FIG. 5 is a flow chart showing a method for viewing the content according to the embodiment of the present invention;

FIG. 6a is a diagram showing the multiplexed left view and the multiplexed right view according to the embodiment of the present invention;

FIG. 6b is a diagram showing an example that a viewer views the video as well as the subtitle according to the embodiment of the present invention;

FIG. 6c is a diagram showing an example that another viewer views only the video according to the embodiment of the present invention;

FIG. 7 is a block diagram showing another presentation apparatus according to the embodiment of the present invention;

FIG. 8 is a block diagram showing another shutter glasses according to the embodiment of the present invention;

FIG. 9a is a diagram showing multiplexed data of left view and right view for the 3D video (multiplexed_L) and multiplexed data of left view and right view for the 3D subtitle (multiplexed_R) according to the embodiment of the present invention;

FIG. 9b is a diagram showing the polarized data based on the multiplexed data according to the embodiment of the present invention;

FIG. 10a is a diagram showing an example that a viewer views the video and the subtitle according to the embodiment of the present invention; and

FIG. 10b is a diagram showing an example that a viewer views the video without the subtitle according to the embodiment of the present invention.

### DETAILED DESCRIPTION

An embodiment of the present invention will now be described in detail in conjunction with the drawings. In the following description, some detailed descriptions of known functions and configurations may be omitted for clarity and conciseness.

According to the principle of the present invention, temporal division technology (temporal filtering) and polarization technology (polarization filtering) are used together to enable more pieces of visual source, e.g. video source or text source (e.g. subtitle), to be presented on a single display for viewers to choose.

According to an embodiment of present invention, the principle of the present is implemented in a 3D environment, where a 3D subtitle is provided during the presentation of 3D video and viewers are allowed to select the 3D subtitle or no 3D subtitle based on his need by wearing a pair of shutter glasses. A person skilled in the art shall know that the selection of a subtitle made by a viewer does not affect the subtitle selection of other viewers. In other words, the subtitle selection is independent for the viewer. In the embodiment, polarization filtering is used to differentiate the left view and the right view, and temporal filtering is used for subtitle selection. As to the environment, all content includes a left view and a right view of a 3D video, a left view and a right view of a subtitle and their synchronization information. The synchronization information for the 3D video and the 3D subtitle indicates the synchronization relationship between the left view of the 3D video, the right view of the 3D video, the left view of the 3D subtitle and the right view of the 3D subtitle.

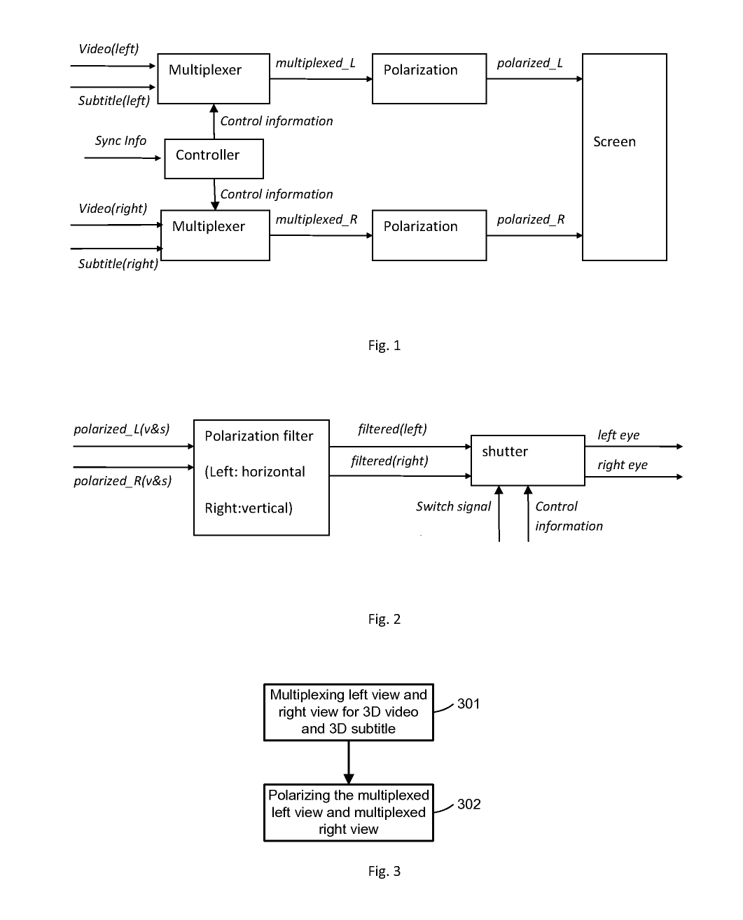

FIG. 1 is a block diagram showing the presentation apparatus according to the embodiment of the present invention and FIG. 2 is block diagram showing the shutter glass according to the embodiment of the present invention.

As shown in the FIG. 1, the presentation apparatus includes two multiplexers, two polarization modules, a controller and a display screen.
The multiplexers are used to base on the synchronization information for the 3D video and the 3D subtitle to combine left view of a 3D video and left view of a 3D subtitle into a stream for left view multiplexed_L, and right view of the 3D video and right view of the 3D subtitle into a stream for right view multiplexed_R.
The polarization modules are used to horizontally and vertically polarize the streams outputted from the multiplexers. In the example, the stream for the left view is horizontally polarized to produce a polarized data for left view polarized_L and the stream for the right view is vertically polarized to produce a polarized data for right view polarized_R. Although horizontal and vertical polarizations are used in this example, it shall note that other orthogonally polarization can also be used, such as clockwise and anticlockwise polarization.
The controller is used to generate control information for multiplexers based on the synchronization information for the 3D video and the 3D subtitle. The control information, which indicates which time slot is used for which view of which content, is used by multiplexers to multiplex the left view of the 3D video and left view of the 3D subtitle and the right view of the 3D video and the right view of the 3D subtitle. In addition, the control information is transmitted to shutter glasses ether wireless (e.g. in infrared signals) or wired. The control information is used by the shutter glass to synchronize to desired content.
The display screen is used to present the polarized data from the polarization modules.

Although in the example as shown in the FIG. 1 it includes two multiplexers and two polarization modules, a variant of the embodiment may only include one multiplexer and one polarization module.

As shown in the FIG. 2, the shutter glasses include a polarization filter and a shutter. When a viewer wearing the shutter glasses looks at the screen as shown in the FIG. 1, polarized data for the left view and right view (polarized_L and polarized_R) can reach the shutter glasses. Each view comprises a multiplexed data of video and subtitle.
The polarization filter is used to differentiate the stream for the left view and the stream for the right view by orthogonally polarizing the received streams to produce filtered streams for the left view and the right view, i.e. the multiplexed data for the left view and the multiplexed data for the right view. In this example, the multiplexed left view is obtained with horizontally polarization and the multiplexed right view is obtained with vertically polarization.
The shutter is used to synchronize to the desired content based on the control information and the switch signal. The switch signal used by the viewer to indicate which content he wants to watch. It can be implemented by adding a button in the shutter glasses or receiving the switch signal from other device (e.g. a computer, a remote controller etc.) via a wired or wireless connection. The control information is used by the shutter for synchronizing itself to desired time slots corresponding to the desired content. In this example, a desired content for a viewer includes the left view and the right view of the 3D video and the left view and the right view of the 3D subtitle, while a desired content for another viewer includes only the left view and the right view of the 3D video.

In the embodiment, the stream is a sequence of frames occurring in a temporal manner. But at a certain time point, it can be considered that a left video frame, a right video frame, a left subtitle frame and a right subtitle frame are multiplexed and polarized in the presentation apparatus. And correspondingly, the polarized frames are polarized to differentiate the left multiplexed frame and the right multiplexed frame in the shutter glasses.

FIG. 3 is a flow chart showing a method for presenting the content according to the embodiment of the present invention.

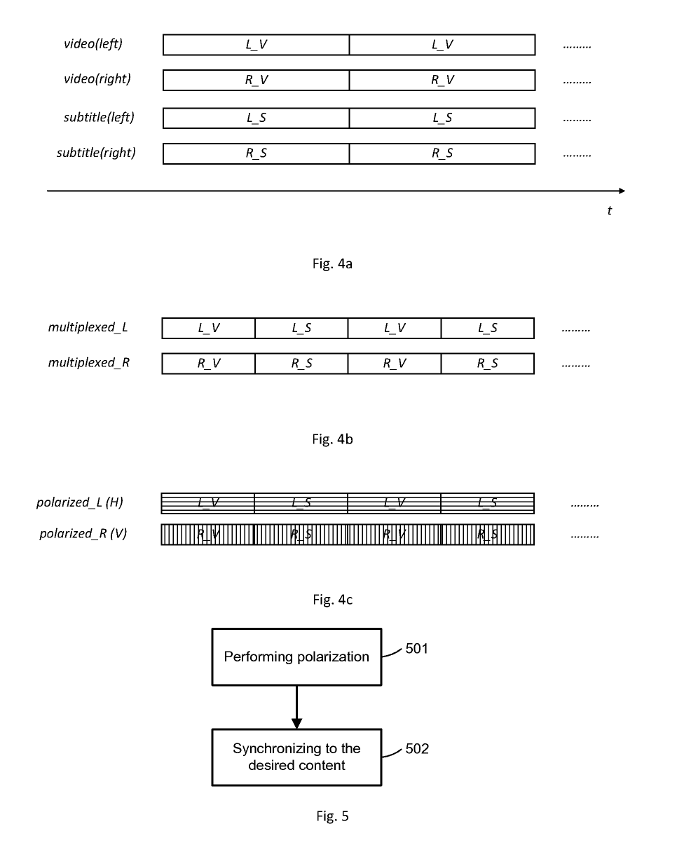

In the step 301, the presentation apparatus multiplexes the left view of the 3D video, the right view of the 3D video, the left view of the 3D subtitle and the right view of the 3D subtitle based on the synchronization information for the 3D video and the 3D subtitle. FIG. 4a is a diagram showing the left views and right views for the 3D video and the 3D subtitle before the multiplexing processing. In the diagram, only two frames for a view are shown, and any frame from any view lasts the same time length. Here, we assume the duration of one frame is T. FIG. 4b is a diagram showing the multiplexed left view and multiplexed right view after multiplexing. Taking the multiplexed left view as example, the multiplexed_L stream includes a sequence of left view frame of the 3D video, left view frame of the 3D subtitle, left view frame of the 3D video, and left view frame of the 3D subtitle. That is, left view frame of the 3D video and left view frame of the 3D subtitle alternately fill the multiplexed left view stream. However, the duration of each frame in the multiplexed left view is shortened to one half of its original duration. It shall note that as the number of the 3D subtitles increases, the duration will be shortened linearly. For example, for n 3D subtitles, the duration of each left (or right) frame is equal to T/(n+1).

In the step 302, the presentation apparatus polarizes the multiplexed left view and the multiplexed right view to produce the polarized left view and polarized right view. FIG. 4 is a diagram showing the polarized left view and polarized right view.

FIG. 5 is a flow chart showing a method for viewing the content according to the embodiment of the present invention.

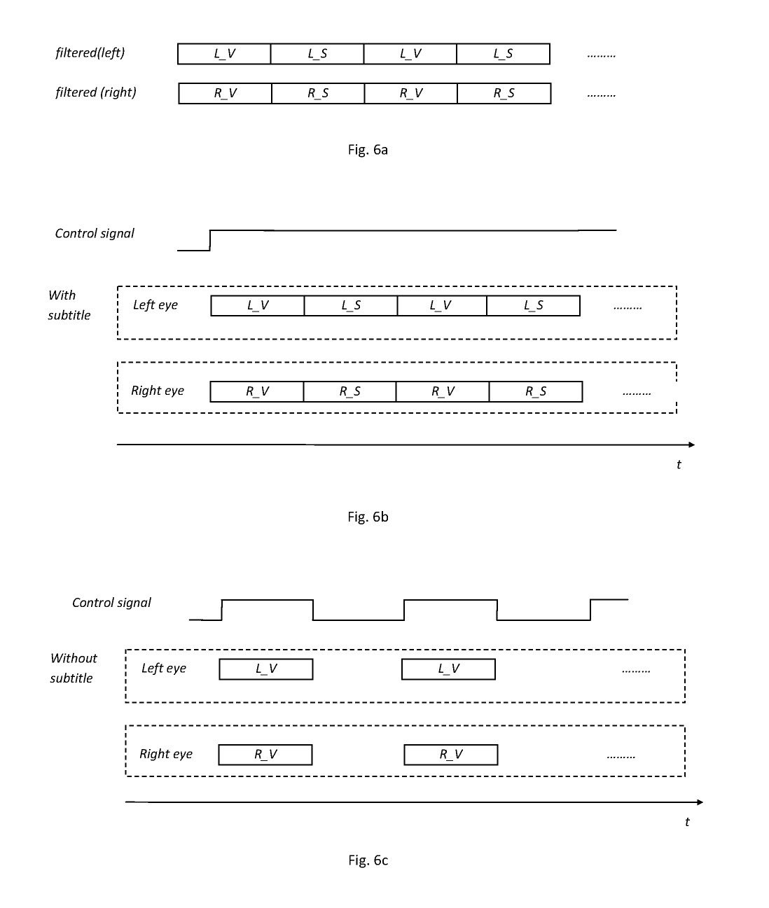

In the step 501, the shutter glasses performs polarization on the content presented by the presentation apparatus to produce the multiplexed left view for the 3D video and the 3D subtitle and the multiplexed right view for the 3D video and the 3D subtitle. FIG. 6a is a diagram showing the multiplexed left view and the multiplexed right view according to the embodiment.

In the step 502, the shutter glasses are synchronized to the desired content based on the control information and the switch signal. Herein, the control information and the switch signal are used to generate control signal for synchronization. FIG. 6b is a diagram showing an example that a viewer views the video as well as the subtitle. FIG. 6c is a diagram showing an example that another viewer views only the video.

Although above embodiment is described with respect to one 3D subtitle, it shall note that the principle of the present invention can also apply for two or more 3D subtitles.

According to a variant embodiment, the content is not limited to video and subtitle. It can be used for other content. For example, presentation of two or more 3D videos, presentation of a 3D video and video comments, actors' information, advertisement etc.

According to a variant embodiment, the principle of the present invention is applied to a portion of the 3D video or several intermittent portions of the 3D video other than the whole 3D video.

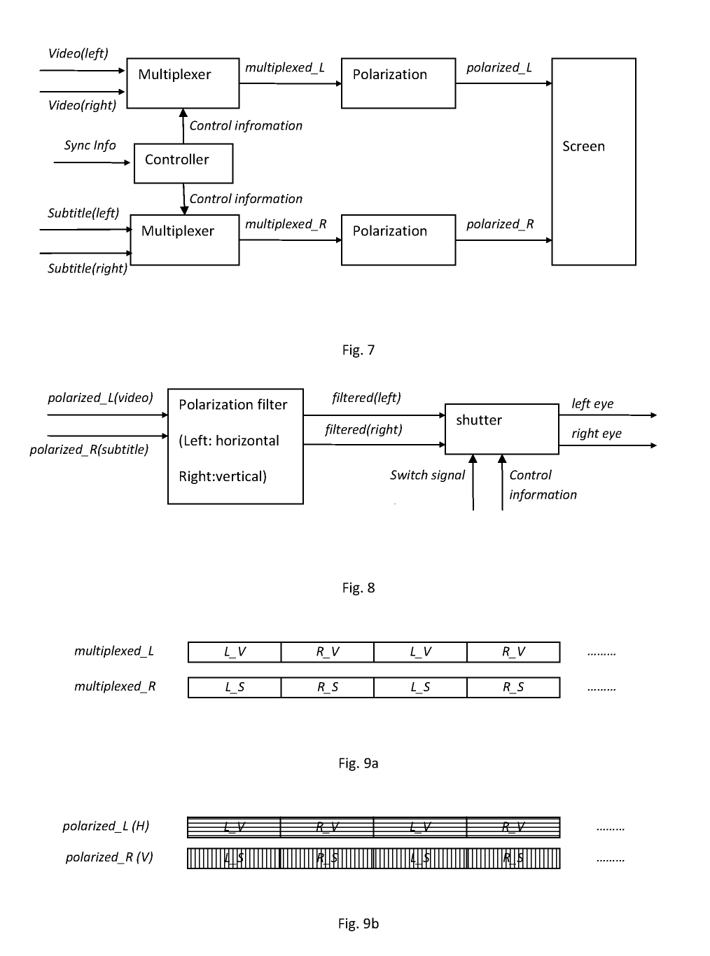

According to another embodiment of the present invention, FIG. 7 is a block diagram showing another presentation apparatus and FIG. 8 is a block diagram showing another shutter glasses.

The difference of the FIG. 7 and FIG. 8 compared to FIG. 1 and FIG. 2 is that they are left view and right view of the 3D video are multiplexed and left view and right of the 3D subtitle are multiplexed.

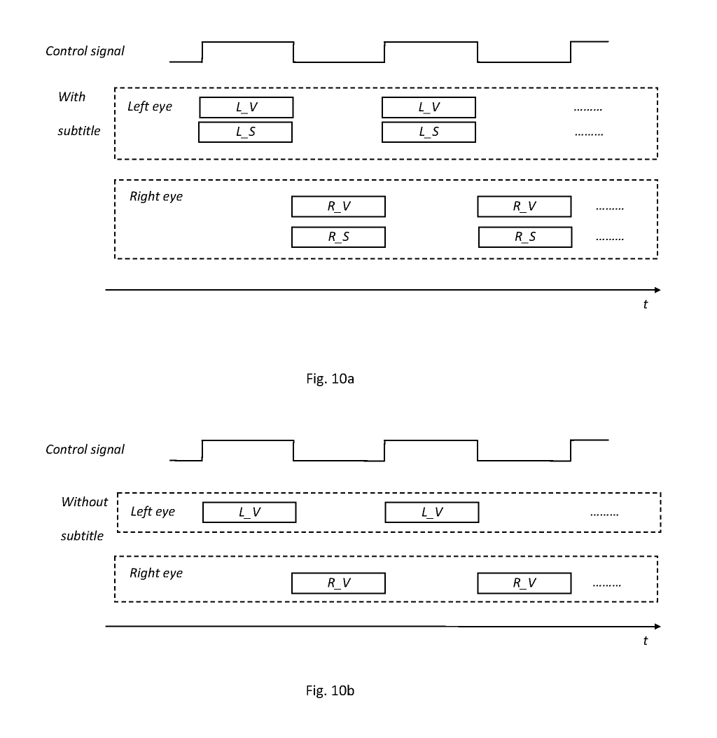

FIG. 9a is a diagram showing multiplexed data of left view and right view for the 3D video (multiplexed_L) and multiplexed data of left view and right view for the 3D subtitle (multiplexed_R). FIG. 9b is a diagram showing the polarized data based on the multiplexed data. FIG. 10a is a diagram showing an example that a viewer views the video and the subtitle. And FIG. 10b is a diagram showing an example that a viewer views the video without the subtitle.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations shall fall in the scope of the invention.

1-10. (canceled)

11. A method for content presentation of a 3D video and a complementary 3D content, wherein the 3D video comprises a left view and a right view and the complementary 3D content comprises a left view and a right view, the complementary 3D content is associated in time with at least a portion of the 3D video, the method comprising the steps of
temporally multiplexing the left view of the portion of the 3D video and the left view of the complementary 3D content to produce multiplexed data for left view and the right view of the portion of the 3D video and the right view of the complementary 3D content to produce multiplexed data for right view;
polarizing the multiplexed data for left view and the multiplexed data for right view to produce polarized data; and
presenting the polarized data.

12. The method of the claim 11, wherein it further comprises a second complementary 3D content that includes a left view and a right view and is associated in time with the portion of the 3D video,
wherein the step of temporally multiplexing further comprising
temporally multiplexing the left view of the portion of the 3D video, the left view of the complementary 3D content and the left view of the second complementary 3D content to produce multiplexed data for left view; and
temporally multiplexing the right view of the portion of the 3D video, the right view of the complementary 3D content and the right view of the second complementary 3D content to produce multiplexed data for right view.

13. The method of the claim 11, wherein the temporally multiplexing further comprises
shortening duration of each frame of the left view of the portion of the 3D video, the left view of the complementary 3D content, the right view of the portion of the 3D video and the right view of the complementary 3D content to half of the frame's original duration.

14. A method for content presentation of a 3D video and a complementary 3D content, wherein the 3D video comprises a left view and a right view and the complementary 3D content comprises a left view and a right view, the complementary 3D content is associated in time with at least a portion of the 3D video, the method comprising the steps of
temporally multiplexing the left view of the portion of the 3D video and the right view of the portion of the 3D video to produce multiplexed data for the 3D video and the left view of the complementary 3D content and the right view of the complementary 3D content to produce multiplexed data for the complementary 3D content;
polarizing the multiplexed data for the 3D video and the multiplexed data for the complementary 3D content to produce polarized data; and
presenting the polarized data.

15. A method for viewing content comprising a 3D video and a complementary 3D content, wherein the 3D video comprises a left view and a right view and the complementary 3D content comprises a left view and a right view, wherein the complementary 3D content is associated in time with at least a portion of the 3D video, and the left view and the right view of the 3D video and the right view of the complementary 3D content are temporally multiplexed and polarized to produce polarized data to be presented on the display, the method comprising the steps of
performing polarization on the polarized data to produce multiplexed data, wherein the multiplexed data comprises time slots conveying the left view and the right of the 3D video and the left view and the right of the complementary 3D content; and
synchronizing to time slots on the multiplexed data, wherein, the time slots corresponds to content among the 3D video and the complementary 3D content a viewer desires to watch.

16. An apparatus for content presentation of a 3D video and a complementary 3D content, wherein the 3D video comprises a left view and a right view and the complementary 3D content comprises a left view and a right view, wherein the complementary 3D content is associated in time with at least a portion of the 3D video, the apparatus comprising
a multiplexer module for temporally multiplexing the left view of the portion of the 3D video and the left view of the complementary 3D content to produce multiplexed data for left view and the right view of the portion of the 3D video and the right view of the complementary 3D content to produce multiplexed data for right view;
a polarization module for polarizing the multiplexed data for left view and the multiplexed data for right view to produce polarized data; and
a screen for presenting the polarized data.

17. The apparatus of the claim 16, wherein it further comprises a second complementary 3D content that includes a left view and a right view and is associated in time with the portion of the 3D video, wherein
a multiplexer module further configured for temporally multiplexing the left view of the portion of the 3D video, the left view of the complementary 3D content and the left view of the second complementary 3D content to produce multiplexed data for left view; and
temporally multiplexing the right view of the portion of the 3D video, the right view of the complementary 3D content and the right view of the second complementary 3D content to produce multiplexed data for right view.

18. The apparatus of the claim 16, wherein
a multiplexer module further configured for shortening duration of each frame of the left view of the portion of the 3D video, the left view of the complementary 3D content, the right view of the portion of the 3D video and the right view of the complementary 3D content to half of the frame's original duration.

19. An apparatus for content presentation of a 3D video and a complementary 3D content, wherein the 3D video comprises a left view and a right view and the complementary 3D content comprises a left view and a right view, wherein the complementary 3D content is associated in time with at least a portion of the 3D video, the apparatus comprising
a multiplexer module for temporally multiplexing the left view of the portion of the 3D video and the right view of the portion of the 3D video to produce multiplexed data for the 3D video, and the left view of the complementary 3D content and the right view of the complementary 3D content to produce multiplexed data for the complementary 3D content;
a polarization module for polarizing the multiplexed data for the 3D video and the multiplexed data for the complementary 3D content to produce polarized data; and
a screen for presenting the polarized data.

20. An apparatus for viewing content comprising a 3D video and a complementary 3D content, wherein the 3D video comprises a left view and a right view and the complementary 3D content comprises a left view and a right view, wherein the complementary 3D content is associated in time with at least a portion of the 3D video, and the left view and the right view of the 3D video and the right view of the complementary 3D content are temporally multiplexed and polarized to produce polarized data to be presented on the display, the apparatus comprising
a polarization filter for performing polarization on the polarized data to produce multiplexed data, wherein the multiplexed data comprises time slots conveying the left view and the right of the 3D video and the left view and the right of the complementary 3D content; and
a shutter for synchronizing to time slots on the multiplexed data, wherein, the time slots corresponds to content among the 3D video and the complementary 3D content a viewer desires to watch.
